(19) United States
(12) Patent Application Publication
(10) Pub. No.: US 2005/0024675 A1
(43) Pub. Date: Feb. 3, 2005

(54) Delivery of printed documents

(76) Inventor: Michiaki Konno, Fujisawa (JP)

Correspondence Address: SOCAL IP LAW GROUP, 310 N. WESTLAKE BLVD. STE 120, WESTLAKE VILLAGE, CA, 91362, US

(21) Appl. No.: 10/815,153

(22) Filed: Mar. 30, 2004

Related U.S. Application Data
(60) Provisional application No. 60/490,699, filed on Jul. 28, 2003.

(51) Int. Cl. G06F 15/00

(52) U.S. Cl. 358/1.15; 358/1.14

(57) ABSTRACT

There is disclosed systems and methods for controlled delivery of printed documents. A user may direct an electronic document to be printed for a destination user. An image forming apparatus may be selected based on its proximity to the destination user. Proximity may be based upon location or network address.

### RELATED APPLICATION INFORMATION

This application claims priority from Provisional Application No. 60/490,699 filed Jul. 28, 2003, which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field Of The Invention

The present invention relates to delivery of printed documents.

2. Description Of Related Art

On occasion, a user A may want to deliver data, not electrically but in printed form, to one or more users through a printer in a network environment. The network may include a number of printers. Typically, the user A designates the name of the printer which will receive and print the data, such as through a printer driver on the PC of the user A. The designated printer simply prints the data upon receipt.

In the case of the prior art, the printed form might be disposed of if the receivers forget to receive it since it is not recognized who outputted the printed form.

### DESCRIPTION OF THE DRAWINGS

FIG. 1 is a block diagram showing an example of a network environment.

FIG. 2 is a flowchart of a method of directing print jobs.

FIG. 3 is a flowchart of setup for the destination in the flowchart in FIG. 2.

FIG. 4 is a flowchart of setup for an image forming apparatus and other settings.

FIG. 5 is a table showing data for a database.

FIG. 6 is a display screen for inputting a lock code

FIG. 7 is a screen shot of a printer driver window.

FIG. 8 is a pop-up window for selecting recipients from an address book.

FIG. 9 is an email notice to recipients.

FIG. 10 is a control panel of an image forming apparatus.

FIG. 11 is a display of a print tab.

FIG. 12 is a selecting screen.

### DETAILED DESCRIPTION OF THE INVENTION

Throughout this description, the embodiments and examples shown should be considered as exemplars, rather than limitations on the apparatus and methods of the present invention.

A feature, referred to herein as “delivery printing.” would be performed, for example, for sending the printed form to members who attend an in-house meeting, for controlling the delivery number-of-copies so that it may not be changed easily, or for prohibiting transmission of the data to many and unspecified persons via email.

Methods are provided which maintain a security protection in case of the delivery printing is designated, and recognize if the recipients receive the printed form delivered by the delivery printing.

Description of the System

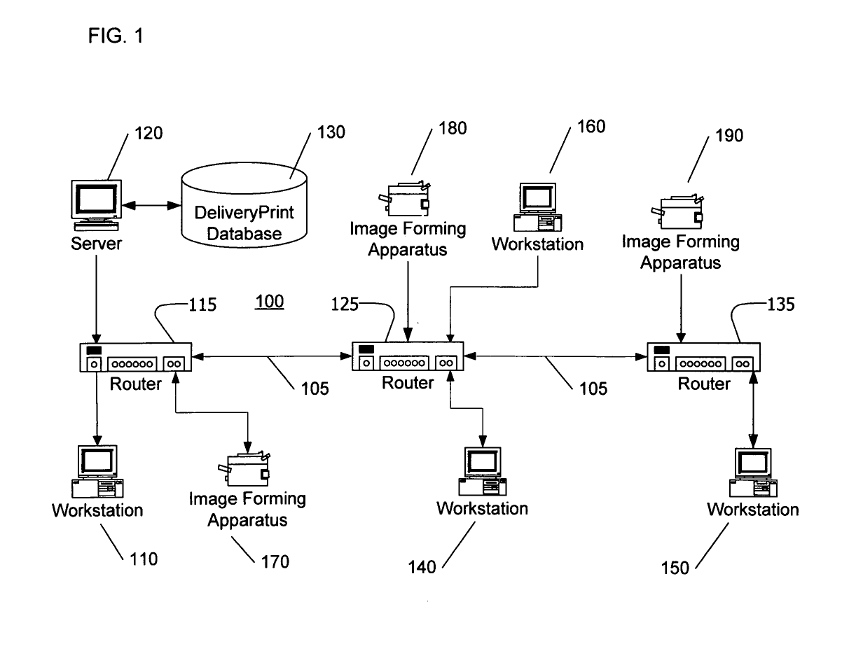

FIG. 1 shows a network environment 100 concerning this embodiment. The network environment includes a communications medium 105, a number of workstations 110, 140, 150, 160, a number of image forming apparatuses 170, 180, 190, a server 120, a database 130 and a number of routers 115, 125, 135. Various devices may be interconnected in the network environment 100 as shown in FIG. 1 and may thereby communicate.

The communications medium 105 provides lower layer network support for data communications. The communications medium 105 may be packet-switched and may comprise a common or private bi-directional data network. The communications medium 105 may include wires, fiber, wireless and/or otherwise.

The routers 115, 125, 135 provide higher layer network support, and are exemplary of various “inside the cloud” devices such as hubs and switches. The routers 115, 125, 135 may support or represent network segments for the devices connected thereto. For example, the router 115 might support the first floor of a company, the router 125 might support the second floor, and the router 135 might support the third floor.

The workstations 110, 140, 150, 160 may be general purpose computers, such as PCs, having a user-oriented operating system and applications. Users of the workstations 110, 140, 150, 160 may create documents, drawings and other matter using various applications. Those documents, drawings and matter may be outputted from the workstations to the image forming apparatuses 170, 180, 190.

The image forming apparatuses 170, 180, 190 may be printers, multifunction peripherals (MFP), or similar devices which form images on output media. The image forming apparatuses 170, 180, 190 can generate output on the output media in response to instructions for forming the images on the output media. These instructions will be referred to herein as a “print job,” though the term is not intended to be limited to printed output. A unit of printed output will be referred to herein as a printed document. Thus, the image forming apparatuses 170, 180, 190 may execute printing when they receive print instructions for a print job. The image forming apparatuses may be located in various places, such that, for example, each floor of a company is served by a respective image forming apparatus 170, 180, 190.

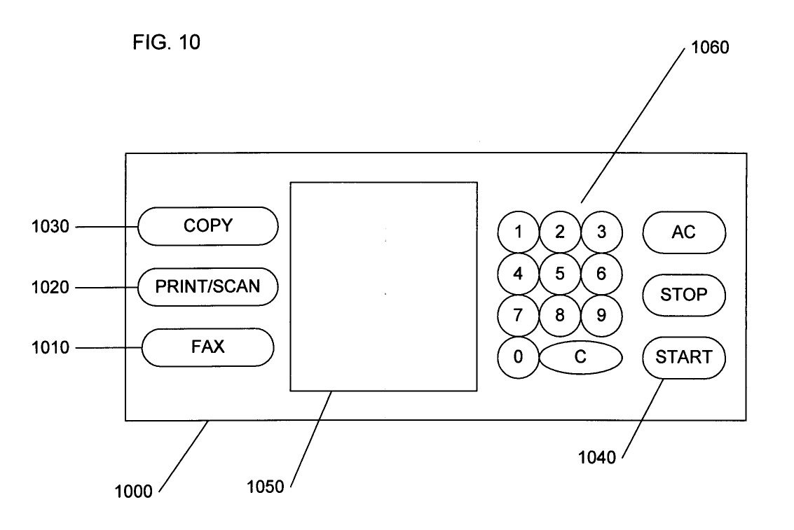

Referring briefly to FIG. 10, there is shown a control panel 1000 of an image forming apparatus which is an MFP. The control panel 1000 includes a fax button 1010, a print/scan button 1020, a copy button 1030, a start button 1040, a display 1050 and a number pad 1060. The copy button 1030 enables the copy function, the print/scan button 1020 enables a network print function and the network scanner function, and the fax button 1010 enables a fax function. The display 1050 provides display output to the user, and may be a touch screen to allow user input through soft buttons. The start button 1040 may be used to start a process, and the number pad 1060 may be used to enter numbers or codes.

The server 120 may be a general purpose computer having server software. The server 120 may be a single server as shown, or may be a group of two or more servers, and may include network devices such as routers, gateways, switches and others. The server 120 may be any server computer.

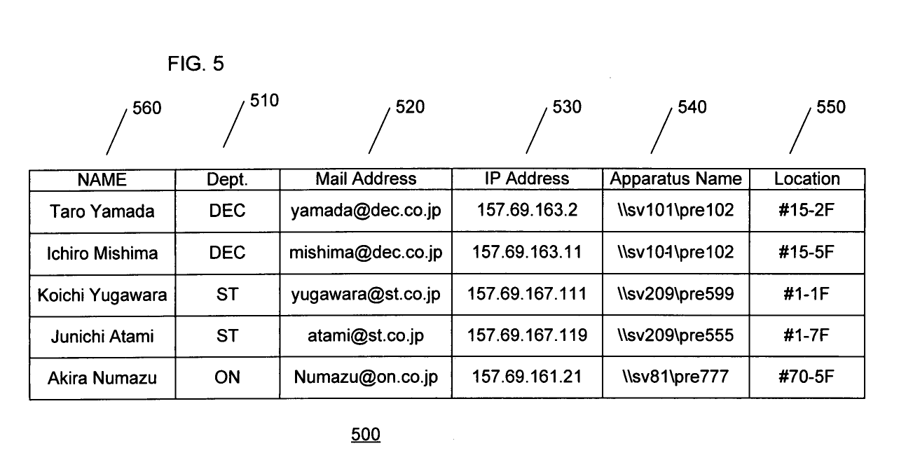

The database 130 is connected to the server 120. Alternatively, the database 130 may be integrated with the server 120 or connected directly to the communications medium 105. The database 130 may be relational, flat, and/or otherwise. Referring briefly to FIG. 5, there is shown a table 500 showing data for the database 130. The database 130 may include columns for user names 560, departments 510, email addresses 520, network addresses 530, image forming apparatuses 540 and locations 550. The image forming apparatus data 540 may show the image forming apparatus nearest to the respective user. The data in the database 130 may be prepared in advance or on-the-fly, and may be prepared and/or maintained manually, automatically or both. The database 130 may allow multiple image forming apparatuses to be associated with each user, and may further include rankings based upon the proximity of the image forming apparatuses to the users or otherwise. The database 130 may in addition or separately provide associations between users and departments, and associations between departments and image forming apparatuses. The database 130 may directly or indirectly associate users with image forming apparatuses.

The user names 560 may be potential recipients. The departments 510 may an organization to which the users belong. The email addresses 520 may be the email or other messaging addresses of the users. The network addresses 530 may be the network addresses of the users. The locations 550 may be the physical locations of the users, and may be mailing addresses, mail stops, office numbers, etc.

The devices in the network environment 100 may include software and/or hardware for providing the functionality and features of the invention. They may therefore include one or more of: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The hardware and firmware components may include various specialized units, circuits, software and interfaces for providing the functionality and features of the invention. The invention may be embodied in whole or in part in software which operates on the workstations 110, 140, 150, 160 and/or server 120 and may be in the form of a device driver, an application program, an applet (e.g., a Java applet), a browser plug-in, a COM object, a dynamic linked library (DLL), a script, one or more subroutines, or an operating system component or service. The hardware and software of the invention and its functions may be distributed such that, for example, some components are performed by the workstation 110 and others by other devices.

The workstations 110, 140, 150, 160 may be any computing device. A computing device as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. These computing devices may run any operating system, including, for example, variations of the Linux, Unix, MS-DOS, Microsoft Windows, Palm OS, and Apple Mac OS X operating systems.

The devices may be assigned addresses within the network environment 100. These addresses may be IP addresses, URLs and/or other forms of network identifiers. In the case of IP addresses, the address includes a network section and a host section. All of the devices in a subnet have the same number in the network section, and each device within a subnet has a unique host section. In the case of URLs, the address includes a top level domain name, a second level domain name, possibly higher level domain names, and a device name. All of the devices in a subnet may have the same top level domain name, and second level domain name, and each is unique above that.

The hardware and software of the invention and its functions may be distributed such that some functionality is performed by the workstations 110, 140, 150, 160 and/or the server 120, and other functionality is performed by other computing devices which may be locally or remotely accessible.

Description of the Methods

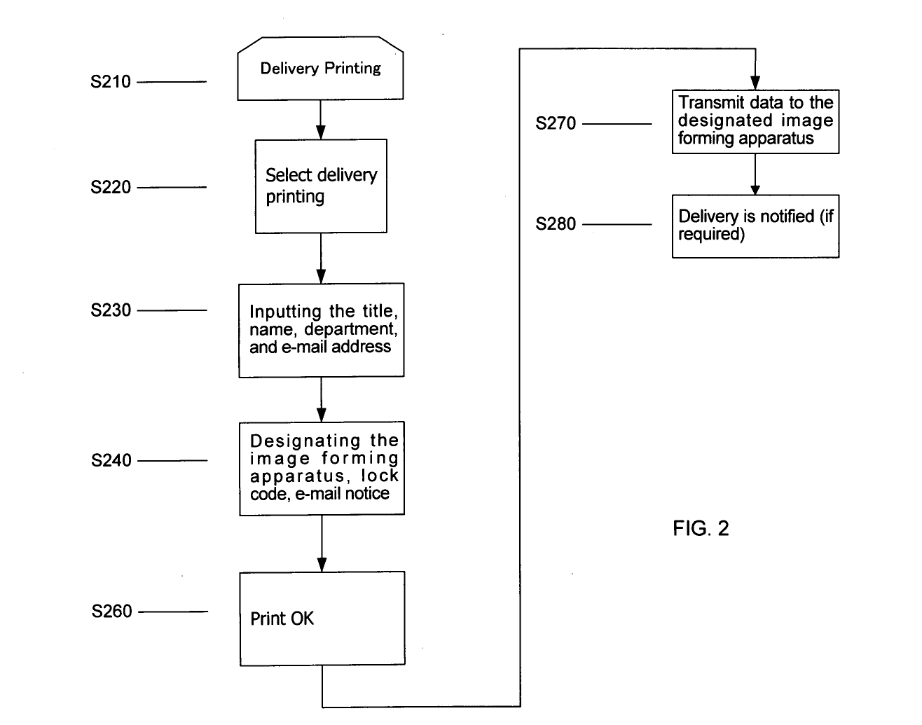

Referring now to FIG. 2, there is shown a flowchart of a method of directing print jobs. In accordance with the method, a user (“the sender”) may designate a document to be printed for one or more users (“the recipients”). This discussion is made with respect to one recipient, though several recipients may be designated by performing several steps repeatedly, and or providing input and display screens to support designation of multiple recipients.

The sender may execute a print command with respect to a designated document or file from within an application or the operating system. A window (not shown) for various setups for printing may open in response to the print command. The window may include various controls, and may include a “Properties” button which allows the sender to access printer-specific settings. These printer-specific settings may be provided by a printer driver installed in or available to the workstation. Different operating systems and applications provide different forms and styles of control over printing and printer settings.

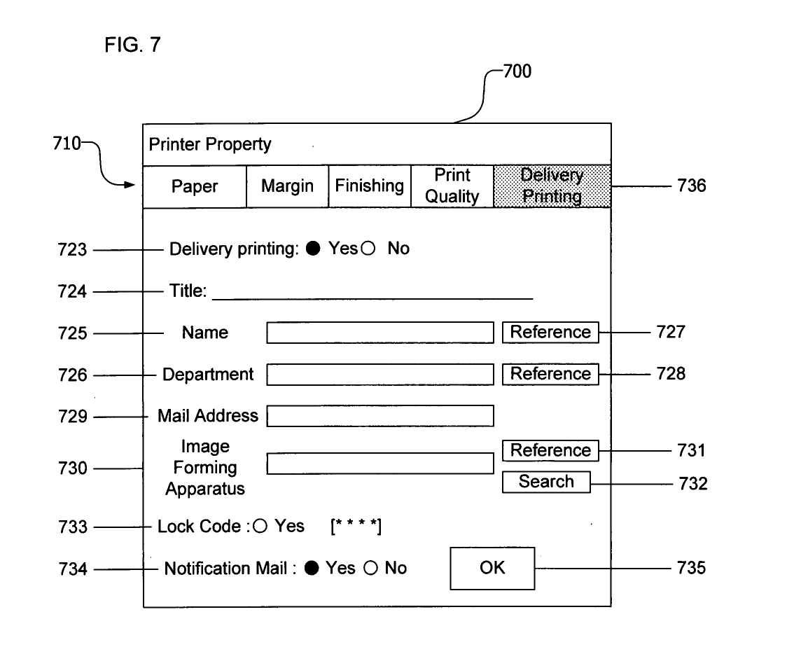

Referring briefly to FIG. 7, there is shown a screen shot of a printer driver window 700 which provides access to printer-specific settings. The sender may access and use the printer driver window 700 to direct print jobs. The printer driver window 700 includes a row of mode tabs 710, including a delivery printing tab 736. In FIG. 7, the delivery printing tab 736 has been selected. The printer driver window 700 with the delivery printing tab 736 selected includes a delivery printing selector 723, a title field 724, a name field 725, a department field 726, an address field 729, an image forming apparatus field 730, a lock code field 733, a notification selector 734, a number of lookup buttons 727, 728, 731 associated with the fields 725, 726, 730, a search button 732 associated with the field 731 and a Print OK button 735. Further discussion of FIG. 2 is now made also with reference to FIG. 7.

In the printer driver window 700, the sender may check the delivery printing selector 723 to select whether the delivery printing feature will be used or not (step S220).

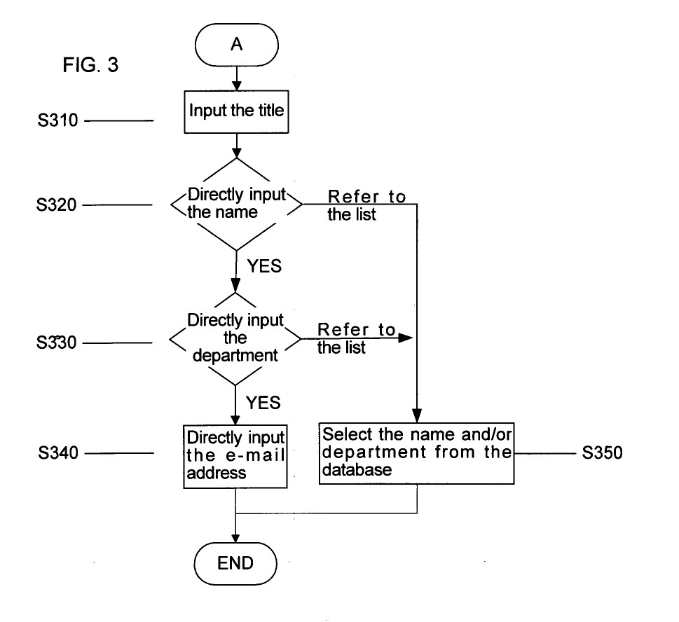

Next, the sender may input a title for the document or print job, or other information, in the title field 724, as well as designate a recipient to receive the printed document using the name field 725, the department field 726 and the address field 729 (step S230). More discussion of step S230 is provided below with respect to FIG. 3.

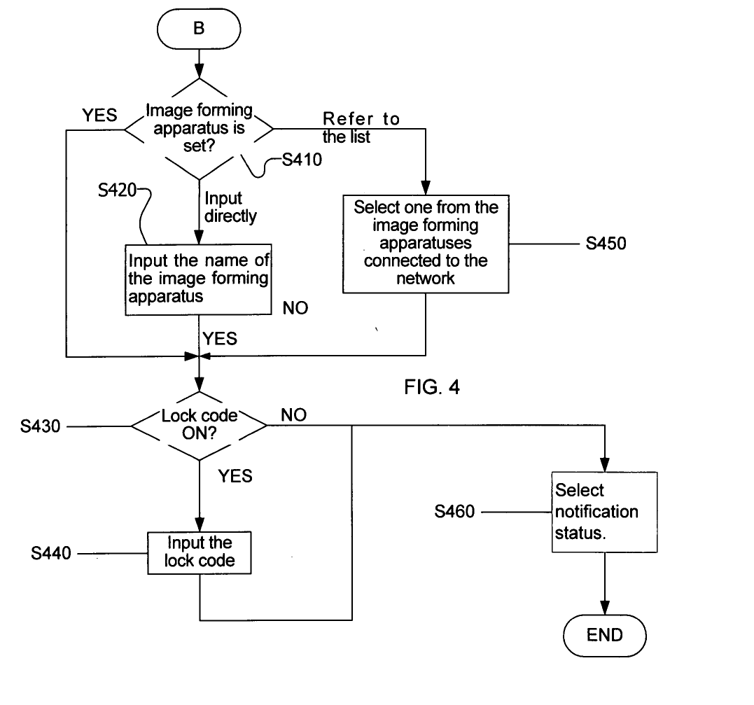

Next, the sender may designate an image forming apparatus to receive the print job in the image forming apparatus field 730, a lock code for the print job in the lock code field 733 and a notification option with the notification selector 734 (step S240). More discussion of step S240 is provided below with respect to FIG. 4.

Next, the sender initiates the print job, for example by clicking on the Print OK button 735 to start the delivery printing (step S260).

After step S260, the workstation causes the print job to be transmitted to the designated image forming apparatus (step S270). If the sender selected notification in step S240, then the address designated in step S230 is used to send a message to the recipient (step S280). Other messaging transports and protocols may be used in addition to or instead of email.

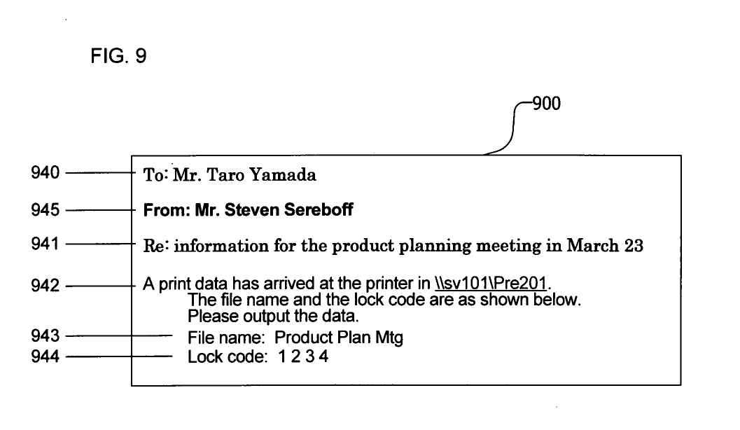

Referring now to FIG. 9, there is shown an example of a message 900 that may be sent to the recipient. The message 900 identifies the recipient 940, a subject line 941, a body message 942, a file name 943, a lock code 944 and a sender name 945. The contents of the title field 724 (FIG. 7) may be used in the subject line 941 of the email message 900. The body message 942 may be preset and include a name of the designated image forming apparatus. The file name 943 may be a file name of a document the sender selected for printing. The lock code 944 may be a code that will allow the printed document to be released. The sender name 945 may identify the sender.

Referring now to FIG. 3, there is shown a flowchart of setup for the destination in the flowchart in FIG. 2 (step S230).

First, a title is inputted (step S310). The title may be a name of a file or document and may be input or selected manually by the user.

Next, the recipient's name may be designated (step S320), as may be the recipient's department (step S330). The recipient's name and the department may be directly inputted. However, they car be also filled in by selecting from an address book (step S350). The address book may be included or work with the database 130.

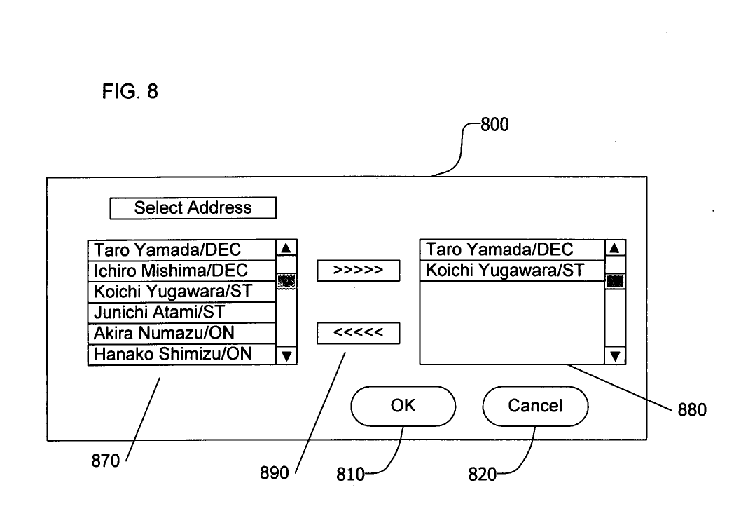

Referring briefly to FIG. 8, there is shown an example of a pop-up window 800 for selecting recipients from an address book. The pop-up window 800 includes a list of available users 870, controls for selecting or deselecting recipients 890 and a list of selected recipients 880. The pop-up window 800 also includes buttons 810, 820 for respectively accepting the list 880 or canceling. The address book may include department and email address.

Next, the recipient's email address may be input (step S340). The email address may be used for sending email notices to the recipient. The email addresses can be directly inputted, may be obtained from the address book, or otherwise. The email address may be automatically selected, although the sender may be permitted to modify the selected email address.

Referring now to FIG. 4, there is shown a flowchart of designation of image forming apparatuses and other settings. Designation of the image forming apparatuses is performed in steps S410, S420 and S450. In step S410, it may be checked if image forming apparatus has been designated already, such as in step S360 (FIG. 3). If the image forming apparatus is already designated, there may be a check of the designations, and the sender may be provided with alternatives to the previously designated image forming apparatuses. In either case, an image forming apparatus may be designated manually (step S420) or automatically (step S450).

In manual designation (step S420), the sender may manually enter address or other identifying information for an image forming apparatus.

In automatic designation (step S450), the sender may be provided no control over the designation of image forming apparatuses, or the sender may select from available and/or recommended image forming apparatuses. Selection may be made from a list displayed in a pop-up window, similar to that shown in FIG. 8. The list presented to the sender may include a ranking assigned to each listed image forming apparatus.

Available image forming apparatuses may be identified in several ways and combinations thereof. The image forming apparatuses may be identified from a search of the database 130. The database may associate image forming apparatuses with users based upon proximity. The proximities may be based upon linear distance between the users and the image forming apparatuses, based upon convenience of the users to the image forming apparatuses, or other measures. Convenience may include actual, estimated or perceived time for a recipient to move from a predefined location such as his workstation to the respective image forming apparatuses. Associations in the database 130 may also take into account workload distribution, and whether some image forming apparatuses have limited access privileges.

Apart from the database 130, image forming apparatuses may be identified from a search. The search may be initiated by the sender (for example by clicking on the search button 732 in FIG. 7), or may be initiated automatically. In performing the search, several kinds of information about the recipients may be available and used, including: network address (e.g., IP address, URL, email address), network nickname, subnet name, email address, department, and/or physical location. Likewise, in performing the search, several kinds of information about the image processing apparatuses may be available and used, including: network address, apparatus name, subnet name, department, and/or physical location.

All or part of the search may be performed by the sender's workstation or by another device, such as the server 120 (FIG. 1), an image processing apparatus, or another device or combination thereof. Best-fit matching techniques may be used. For example, using IP addresses, all image forming apparatuses in the same subnet as the recipient may be selected, and they may be ranked based upon the closeness in value of their host section. Furthermore, the search, and various forms of the search, may be combined, and may be combined with lookups in the database 130 and/or other databases.

The delivery printing will be available to the image forming apparatus nearest to the recipient's workstation accordingly. Besides, even in case the value of the host section is the nearest, it may be some distance from the place in which the printer is actually installed. Therefore, for the image forming apparatuses which have the same value for the network section, order of selection can be decided freely.

A security feature may be provided to control release of the printed document. This may be useful if the sender wants a measure of security for the print job and/or the printed documents. If the sender selects use of the security feature (step S430), the sender may be asked to enter a lock code, such as a 4-digit number (step S440). The lock code may be provided to the recipients via a notification message. The lock code may be used as a prerequisite to various steps in the printing process. Thus, entry of the lock code may be required, for example: immediately upon the sender transmitting the print job; upon receipt of the print job by the designated image forming apparatus; after ripping but before printing; upon printing but prior to release from a physical container.

The sender may select notification of the print job to the recipients (step S460). The notification times may be comparable to those described with respect to entry of the lock code.

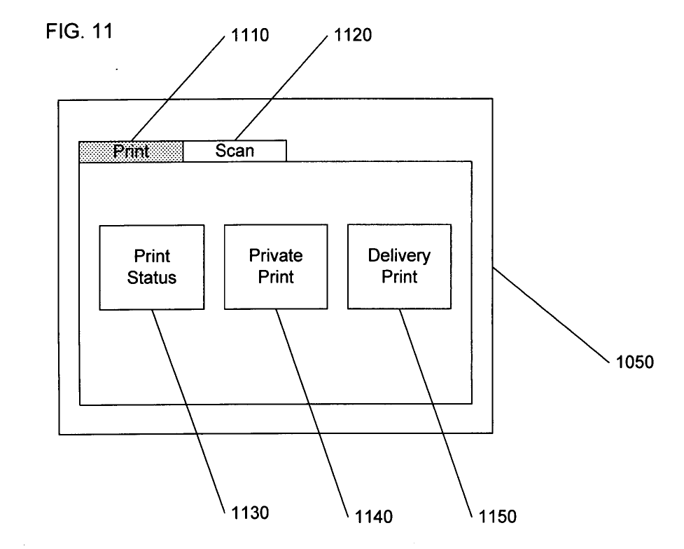

The print processing at the destination after performing the delivery printing is explained with respect to FIGS. 9 to 12. As explained above, FIG. 9 is an example of an email message 900 that may be sent to the recipients. By opening this email in his workstation, the recipient can recognize that a print job was sent to the designated image forming apparatus.

The recipient can then go to the designated image forming apparatus to retrieve the printed document. The document may have been printed upon receipt, or may be held in a queue (in the designated image forming apparatus or elsewhere) and waiting to be printed. In the latter case, the recipient causes the document to be printed, either from his workstation (e.g., via a printer driver) or from the designated image forming apparatus.

At the designated image forming apparatus, the recipient may initiate printing or release of the printed document. For example, the recipient might depress the PRINT/SCAN button 1020 on the control panel 1000 (FIG. 10). Then, the display screen 1050 may change to show a display such as that shown in FIG. 1 1. The display screen 1050 includes a print tab 1110 for selecting a network print function and a scan tag 1120 for selecting the network scanner function. If the print tab 1110 is selected in this working example, the buttons for function selection may be displayed. The functions may include print status 1130 which displays the processing situation of the print data, private print 1140 for which a user selects print data from the HDD in which the print data was transmitted and stored, and delivery print 1150.

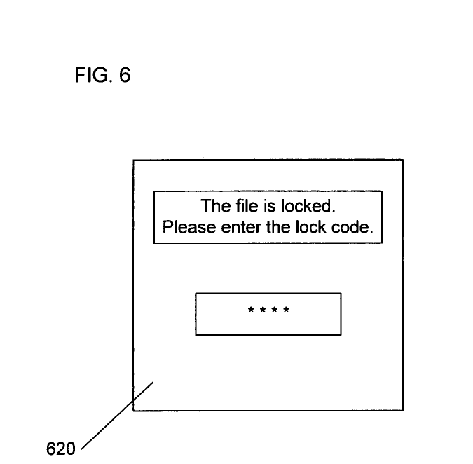

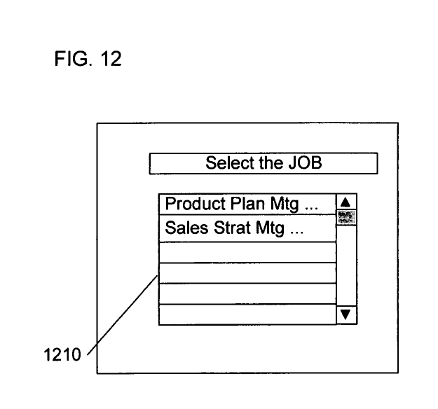

If the delivery print button 1150 is depressed, the display screen 1050 may show a list of file names 610 of the data received by the delivery printing as shown in FIG. 12. The recipient may select the document that was sent to him from the list 1210, and initiate printing by depressing the start button 1040 on the control panel 1000. If the sender set a lock code for the document, the recipient may be asked to enter the lock code. FIG. 6 shows a display for the display screen 1050 for inputting a lock code.

Delivering important documents, such as confidential documents, by file basis may cause a security problem since the contents of the file can be altered easily. However, this invention enables to improve the informational confidentiality and reduce man hour and time for delivery. Moreover, since the data is delivered to the nearest image forming apparatus to the destination user, he can get information promptly.

With regard to FIGS. 2-4, additional and fewer steps may be taken, and the steps as shown may be combined or further refined to achieve the methods described herein.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

1. A method of delivering printed documents comprising
inputting a name of a destination user
inputting a network address corresponding to the name of the destination user
a reference step to select an image forming apparatus based upon information selected from the group comprising the name and the mail address
a distribution step to deliver the electronic data to the image forming apparatus selected by the reference step.

2. The method of delivering printed documents of claim 1 comprising setting up a lock code.

3. The method of delivering printed documents of claim 1 comprising setting up sending a notification mail which notifies that the electronic data has been transmitted to the mail address inputted at the mail address inputting step when delivering the electronic data to the selected image forming apparatus.

4. A printing program which delivers electronic data for printing, the program comprising
a function to input a name of a destination user to which a printed document from the electronic data is to be delivered
a function to input a network address corresponding to the name of the destination user
a function to select an image forming apparatus from information selected from the group comprising the name or the mail address
a function which delivers the electronic data to the selected image forming apparatus.

5. A method of delivering printed documents, the method comprising
receiving information about a print job to be printed, wherein the information identifies a user to receive a printed documents from the print job
selecting an image forming apparatus based upon information about the identified user, wherein the selection is made from a search of database, wherein the database associates plural image forming apparatuses with plural users
directing the print job to the selected image forming apparatus.

6. The method of directing print jobs of claim 5 wherein the information comprises the print job.

7. The method of directing print jobs of claim 5 further comprising, after the selecting step and before the directing step, requesting confirmation of the selected image forming apparatus and receiving a confirmation of the selected image forming apparatus.

8. The method of directing print jobs of claim 5 further comprising
in the selecting step, preparing a list of image forming apparatuses from the database, the list ranking the listed image forming apparatuses based upon the proximity of the listed image forming apparatuses to the identified user
after the selecting step, requesting selection of one of the image forming apparatuses from the list.

9. The method of directing print jobs of claim 5 further comprising notifying the selected user of the print job.

10. The method of directing print jobs of claim 9 wherein the notifying comprises sending a message to the user with information identifying the selected image forming apparatus.

11. The method of directing print jobs of claim 5 further comprising including a tracking identifier in the print job for identifying a printed document corresponding to the print job.

12. A method of delivering printed documents, the method comprising
receiving information about a print job to be printed, wherein the information identifies a user to receive the print job
obtaining a network address of the identified user
selecting at least one of a plurality of image forming apparatuses having a network address closest to the network address of the identified user
directing the print job to the selected image forming apparatus.

13. The method of delivering printed documents of claim 12 wherein the information comprises the print job.

14. The method of delivering printed documents, of claim 12 further comprising, after the selecting step and before the directing step, requesting confirmation of the selected image forming apparatus and receiving a confirmation of the selected image forming apparatus.

15. The method of delivering printed documents of claim 12 wherein the selecting step further includes searching a database, wherein the database associates plural image forming apparatuses having respective network addresses.

16. The method of delivering printed documents of claim 12 further comprising
in the selecting step, preparing a list of image forming apparatuses, the list ranking the listed image forming apparatuses based upon the proximity of the listed image forming apparatuses to the identified user
after the selecting step, requesting selection of one of the image forming apparatuses from the list.

17. The method of delivering printed documents of claim 12 wherein
the network addresses comprises an IP address
closeness is determined based upon identity of subnets in the network addresses and closeness of host portions of the network addresses.

18. A storage medium comprising
a database stored on the storage medium which associates plural image forming apparatuses with plural users based upon proximity between the users and the image forming apparatuses
instructions stored on the storage medium which when executed by a processor cause the processor to perform actions comprising
receiving information about a print job to be printed, wherein the information identifies a user to receive a printed document from the print job
selecting one of the image forming apparatuses based upon information about the identified user
directing the print job to the selected image forming apparatus.

19. The storage medium of claim 17 wherein the information comprises the print job.

20. The storage medium of claim 17 further comprising instructions stored on the storage medium which when executed by the processor cause the processor to perform actions comprising requesting confirmation of the selected image forming apparatus and receiving a confirmation of the selected image forming apparatus.

21. The storage medium of claim 17 further comprising instructions stored on the storage medium which when executed by a processor cause the processor to perform actions comprising
preparing a list of image forming apparatuses from the database, the list ranking the listed image forming apparatuses based upon the proximity of the listed image forming apparatuses to the identified user
requesting selection of one of the image forming apparatuses from the list.

22. A workstation comprising the storage medium of claim 17.

23. A storage medium comprising
instructions stored on the storage medium which when executed by a processor cause the processor to perform actions comprising
receiving information about a print job to be printed, wherein the information identifies a user to receive the print job
obtaining a network address of the identified user
selecting at least one of a plurality of image forming apparatuses having a network address closest to the network address of the identified user
directing the print job to the selected image forming apparatus.

24. The storage medium of claim 23 wherein the information comprises the print job.

25. The storage medium of claim 23 further comprising instructions stored on the storage medium which when executed by the processor cause the processor to perform actions comprising requesting confirmation of the selected image forming apparatus and receiving a confirmation of the selected image forming apparatus.

26. The storage medium of claim 23 further comprising instructions stored on the storage medium which when executed by the processor cause the processor to perform actions comprising
preparing a list of image forming apparatuses, the list ranking the listed image forming apparatuses based upon the proximity of the listed image forming apparatuses to the identified user
requesting selection of one of the image forming apparatuses from the list.

27. A workstation comprising the storage medium of claim 23.
